(19) United States
(12) Patent Application Publication
(10) Pub. No.: US 2015/0166047 A1
(43) Pub. Date: Jun. 18, 2015

(54) METHOD FOR GEARCHANGE OF A HYBRID VEHICLE

(71) Applicant: SCANIA CV AB, Södertälje (SE)

(72) Inventors: Niklas Pettersson, Stockholm (SE); Mikael Bergquist, Huddinge (SE); Johan Lindström, Nykoping (SE); Anders Kjell, Ekero (SE); Mathias Björkman, Tullinge (SE)

(21) Appl. No.: 14/410,618

(22) PCT Filed: Jun. 26, 2013
(86) PCT No.: PCT/SE2013/050776

§ 371 Date: Dec. 23, 2014

(30) Foreign Application Priority Data
Jun. 27, 2012 (SE) 1250702-6

(51) Int. Cl. B60W 20/00; B60W 10/11; B60W 10/06; B60W 10/08; B60W 30/19; F16H 61/04

(52) U.S. Cl. CPC B60W 20/108; B60W 30/19; F16H 61/0403; B60W 10/06; B60W 10/08; B60W 10/11; F16H 2061/0422; Y10S 903/93

(57) ABSTRACT

A method for gearchange in a gearbox during driving of a vehicle, the vehicle having a propulsion system including a combustion engine with an output shaft (2a), a gearbox (3) with an input shaft (3a), an electric machine (9) comprising a stator and a rotor, and a planetary gear comprising a sun gear (10), a ring gear (11) and a planet wheel carrier (12). The gearchange takes place with the members of the planetary gear interlocked.

### CROSS-REFERENCE TO RELATED APPLICATIONS

The present application is a 35 U.S.C. §§371 National Phase conversion of PCT/SE2013/050776, filed Jun. 26, 2013, which claims priority of Swedish Patent Application No. 1250702-6, filed Jun. 27, 2012, the contents of which are incorporated by reference herein. The PCT International Application was published in the English language.

### FIELD OF THE INVENTION AND PRIOR ART

The present invention relates to a method for a gearchange in a gearbox during driving of a vehicle.

The invention is especially but not exclusively directed to carrying out such a method for motor vehicles in the form of wheeled utility vehicles, especially heavy vehicles, such as trucks and buses.

Accordingly, the invention relates to a method for a gearchange in a gearbox during driving of a hybrid vehicle. That vehicle generally may be driven by a primary engine, here a combustion engine, and a secondary engine, here an electric machine. The electric machine is suitably provided with means for storing energy, such as a battery or a capacitor for storing electric energy, and with regulating equipment for regulating the flow of electrical energy between said storing means and the electric machine. The electric machine may by this operate as a motor or a generator, depending upon the state of operation of the vehicle. When the vehicle is braked, the electric machine generates electrical energy which may be stored, and the stored electrical energy may later be utilized for, for example, driving the vehicle.

The utilization of a conventional clutch mechanism disconnecting the input shaft of the gearbox with respect to the combustion engine during the gearchanging process in the gearbox results in disadvantages, such as heating of the discs of the clutch mechanism, which results in an increased fuel consumption and wear of the clutch discs. Considerable losses are then also caused when starting the vehicle. Furthermore, a conventional clutch mechanism is comparatively heavy and costly. It requires also a comparatively large space in the vehicle. Friction losses are also created when using a hydraulic converter/torque transformer usually used in automatic gearboxes. The conventional clutch mechanism and said disadvantages associated therewith may be avoided by providing for that vehicle a propulsion system in which the output shaft of the combustion engine, the rotor of the electric machine and the input shaft of the gearbox are interconnected by a planetary gear. A vehicle having a propulsion system of this type is known from EP 1 319 546.

There is of course an ongoing attempt to improve the way to drive a vehicle having such a propulsion system with respect to energy efficiency and to regenerate as much as possible of the brake energy when braking the vehicle.

### SUMMARY OF THE INVENTION

The object of the present invention is to provide a method of the type defined in the introduction.

A gearchange with a planetary gear maintained in a locked position may be efficiently performed through the method according to the invention. This causes a reduced wear of thelocking means with respect to the case if the locking means would be actuated in connection with the gearchange. A gearchange with locked planetary gear components is most suitable when there is no high demand for a quick gearchange, for instance, at higher substantially constant speeds.

According to an embodiment of the invention the method is performing for a vehicle having a propulsion system with the sun gear as the first component and the ring gear as the third component, and such a propulsion system is described in unpublished SE 1051384-4. It has a number of advantages with respect to a propulsion system according to EP 1 319 546 mentioned above, which has the ring gear as the first component and the sun gear as the third component. A compact construction is easy to build in already existing spaces for drivetrains (propulsion systems) having clutch mechanisms instead of planetary gears. The compact construction is obtained by connecting the electric machine with the ring gear and connecting the output shaft of the combustion engine with the sun gear. Such a hybridized gearbox may be made of a size and weight compatible with a standard gearbox, and standardized interfaces may be maintained. This means that the weight increase normally associated with hybridization may be reduced considerably. Another advantage is that a connection of the electric machine with the ring gear means a higher possible brake torque than would be obtained if the electric machine were instead connected to the sun gear.

According to another embodiment of the invention during a step preceding a gear change, the time remaining until the synchronized rotational speed of the input shaft of the gearbox is obtained is calculated and this time is compared with an expected time consumption for the gearengaging procedure. The gearengaging procedure is started when the time is equal to or has become shorter than the time consumption. The method may as a result be shortened, since the new gear may be engaged without any real delay at the moment for obtaining synchronized rotational speed. This avoids jerks during the gearchange and is advantageous from the energy consumption point of view.

According to another embodiment of the invention, a constant torque is applied through the electric machine and/or a constant torque is applied through the combustion engine to the input shaft of the gearbox. The method is simplified considerably by applying a constant torque of suitable magnitude so as to obtain the synchronized rotational speed of the input shaft of the gearbox.

According to another embodiment of the invention, when a higher gear is engaged in the gearbox in step d) than the gear which was engaged before the method was started, the combustion engine is controlled to apply a negative torque, i.e. a braking torque, to the input shaft of the gearbox through activating an exhaust gas brake of the vehicle and/or by activating a so-called variable geometry turbo so as to apply a negative torque to the input shaft of the gearbox.

According to another embodiment of the invention, the method is carried out for a vehicle having the sun gear and the planet wheel carrier interlocked through the locking means, which enables a realization of the locking means in a simple and reliable way. Less torque may by this be transferred through the planetary gear wheels. Only the torque of the electric machine is then transferred through these gear wheels.

According to another embodiment of the invention, a step comprises calculation of the rotational speed which for the existing speed of the vehicle the input shaft of the gearbox would get if the gear of the gearbox to be engaged would have been engaged and a calculation of the rotational speed of the third component and the rotational speed of the output shaft of the combustion engine which together would give the input shaft of the gearbox said rotational speed calculated for the gear to be engaged.

Other advantageous features and advantages of the invention appear from the description following below.

### BRIEF DESCRIPTION OF THE DRAWINGS

With reference to the appended drawings, below follows a specific description of an embodiment of the invention cited as an example.

In the drawings:

FIG. 1 is a very simplified view of a drivetrain of a vehicle for which a method according to the invention may be carried out,

FIG. 2 is a still simplified but more detailed view of a part of a said propulsion system,

FIG. 3 is a principle sketch of an electronic control unit for implementing a method according to the invention, and

FIG. 4 is a flow chart illustrating a method according to an embodiment of the invention.

### DETAILED DESCRIPTION OF AN EMBODIMENT OF THE INVENTION

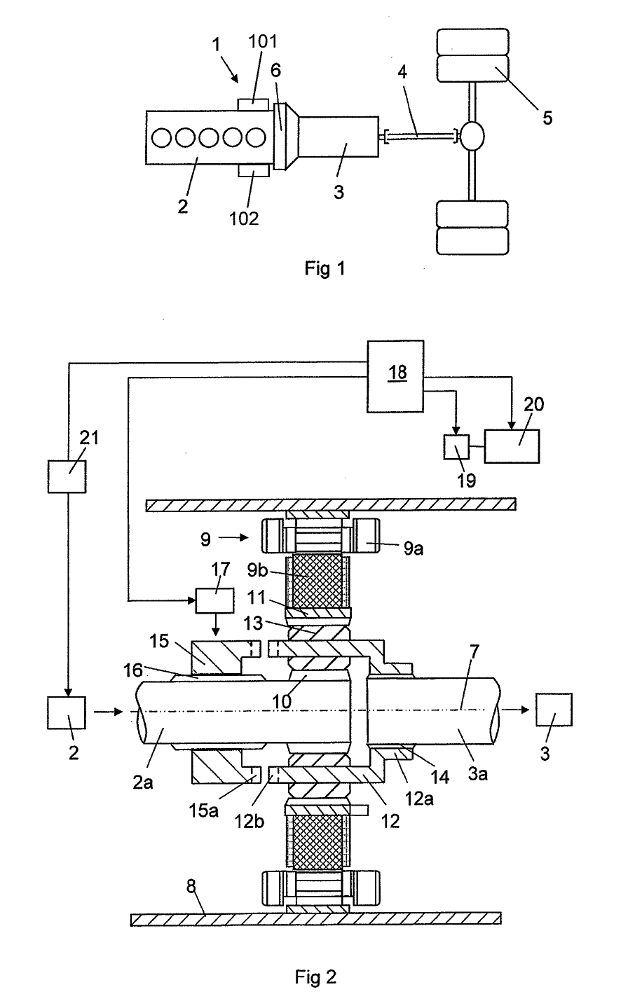

FIG. 1 shows a drivetrain for a heavy vehicle 1. The drivetrain comprises a combustion engine 2, a gearbox 3, a number of drive shafts 4 and drive wheels 5. The drivetrain has between the combustion engine 2 and the gearbox 3 an intermediate portion 6. FIG. 2 shows the components in the intermediate portion 6 in detail. The combustion engine 2 is provided with an output shaft 2a and the gearbox 3 with an input shaft 3a in the intermediate portion 6. The output shaft 2a of the combustion engine is arranged coaxially with respect to the input shaft 3a of the gearbox. The output shaft 2a of the combustion engine and the input shaft 3a of the gearbox are arranged to rotate around a rotation axis 7. The intermediate portion 6 comprises a housing 8 enclosing an electric machine 9 and a planetary gear. The electric machine 9 comprises as usual a stator 9a and a rotor 9b. The stator 9a comprises a stator core secured in a suitable way on the inner side of the housing 8. The stator core comprises stator windings. In certain operation situations, the electric machine 9 is adapted to utilize electric energy stored for supplying drive power to the input shaft 3a of the gearbox and in other operation situations utilize kinetic energy of the input shaft 3 of the gearbox for generating and storing electric energy.

The planetary gear is arranged substantially radially internally of the stator 9a and the rotor 9b of the electric machine. The planetary gear comprises as usual a sun gear 10, a ring gear 11 and a planet wheel carrier 12. The planet wheel carrier 12 carries a number of gear wheels 13 which are rotatably arranged in a radial space between the teeth of the sun gear 10 and the ring gear 11. The sun gear 10 is secured to a circumferential surface of the output shaft 2a of the combustion engine. The sun gear 10 and the output shaft 2a of the combustion engine rotate as a unit with a first rotational speed n₁. The planet wheel carrier 12 comprises a fastening portion 12a being fastened to a circumferential surface of the input shaft 3a of the gearbox by means of a splined connection 14. The planet wheel carrier 12 and the input shaft 3a of the gearbox may by means of this connection rotate as a unit with a second rotational speed n₂. The ring gear 11 comprises an external circumferential surface onto which the rotor 9b is secured. The rotor 9b and the ring gear 11 form a rotatable unit rotating with a third rotational speed n₃.

The propulsion system comprises a locking means. The output shaft 2a of the combustion engine is provided with a displaceable coupling member 15. The coupling member 15 is fastened to the output shaft 2a of the combustion engine by means of a splined connection 16. The coupling member 15 is in this case fixed against rotation to the output shaft 2a of the combustion engine and displaceable in the axial direction on the output shaft 2a of the combustion engine. The coupling member 15 comprises a coupling portion 15a connectable to a coupling portion 12b of the planet wheel carrier 12. A displacing member 17 schematically shown is adapted to displace the coupling member 15 between a first position in which the coupling portions 15a, 12b are not mutually engaged corresponding to a releasing position of the locking means and a second position in which the coupling portions 15a, 12b are mutually engaged corresponding to a locking position of the locking means. The output shaft 2a of the combustion engine and the input shaft 3a of the gearbox will in this locking position be interlocked and these and the rotor of the electric machine will by that rotate with the same rotational speed. This state may be called locked planet. The locking mechanism may also comprise a sleeve provided with first splines which in the releasing position engage second splines on a first component of the planetary gear and in the locking position engage third splines on a second component of the planetary gear. The first component is in this case preferably the planet wheel carrier and the second component the sun gear. The locking mechanism may then be designed as a sleeve with a ring shape enclosing the planet wheel carrier substantially concentrically.

An electric control unit 18 is designed to control the displacing member 17. The control unit 18 is also configured to decide on which occasions the electric machine shall operate as a motor or on which occasions it shall operate as a generator. The control unit 18 may for deciding this receive current information about suitable operation parameters. The control unit 18 may be a computer with software for this task. The control unit 18 controls a regulating equipment 19 schematically shown, which regulates the flow of electric energy between a hybrid battery 20 and the stator windings 9a of the electric machine. On occasions when the electric machine 9 operates as a motor, electric energy stored is supplied from the hybrid battery 20 to the stator 9a. On occasions when the electric machine operates as generator, electric energy is supplied from the stator 9a to the hybrid battery 20. The hybrid battery 20 delivers and stores electric energy with a voltage on the order of 200-800 volts. Since the intermediate portion 6 between the combustion engine 2 and the gearbox 3 in a vehicle is restricted, it is required that the electric machine 9 and the planetary gear constitute a compact unit. The components 10, 11, 12 of the planetary gear are here arranged substantially radially internally of the stator 9a of the electric machine. The rotor 9b of the electric machine, the ring gear 11 of the planetary gear, the output shaft 2a of the combustion engine and the input shaft 3a of the gearbox are here arranged to rotate around a rotation axis 7. The electric machine 9 and the planetary gear occupy through such a design a comparatively small space.

The vehicle 1 is provided with a motor control function 21 through which the rotational speed n₁ of the combustion engine 2 may be regulated. The control unit 18 has by that a possibility to activate the motor control function 21 and create a state of zero torque in the gearbox when gears in the gearbox 3 are engaged and disengaged. The propulsion system may instead be controlled by one single control unit 18 be controlled by several different control units.

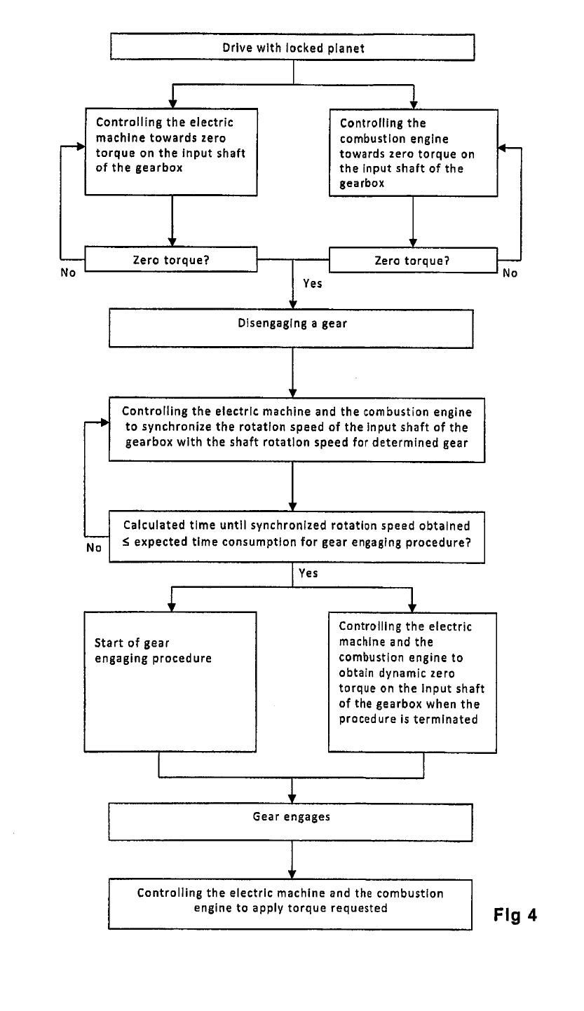

FIG. 4 shows a flow chart illustrating a method according to an embodiment of the present invention for gearchange in a gearbox during driving of a vehicle having a propulsion system of the type shown in FIG. 2.

The vehicle is driven with the locking means in the locking position when the method is started. This means that all three components of the planetary gear rotate with the same rotational speed. A need to change gear in the gearbox of the vehicle is then detected, for example in connection with reaching a high speed, and fuel is to be saved by driving with a higher gear engaged than previously.

The method is started by the control units 18 and 21 controlling the electric machine 9 and the combustion engine 2, respectively, towards a state of together applying a zero torque to the input shaft 3a of the gearbox. There may be any torque distribution among the combustion engine and the electric machine. One of the engine and machine may even apply a negative torque to the input shaft of the gearbox when the method is started. When a total zero torque has been obtained in the combustion engine and the electric machine, the gear in the gearbox is disengaged, i.e. it is changed to neutral in the gearbox. The electric machine and the combustion engine are thereafter controlled to each apply a constant torque to the input shaft of the gearbox for accelerating or retarding the input shaft towards a rotational speed coinciding with the shaft rotational speed for a gear to be engaged in the gearbox. When this is a change upward in the gear, an exhaust gas brake 101 of the vehicle and/or a so-called variable geometry turbo 102 (both in FIG. 1) may be activated for applying a negative torque to the input shaft of the gearbox through the combustion engine, whereas the combustion engine in the case of a change down is controlled to apply a positive torque by injecting fuel. The time remaining until a synchronized rotational speed will be obtained is simultaneously calculated, and this remaining time is compared with an expected time consumption for the gearengaging procedure, which is started when this time is equal to or has become shorter than said time consumption.

When the gearengaging procedure has been started, the electric machine and the combustion engine are controlled to obtain a zero torque to the input shaft of the gearbox when the gearengaging procedure is completed, i.e. when the gear is engaged. The friction torque is estimated for this, and by the knowledge of other parameters the torques of the electric machine and the combustion engine applied for obtaining said zero torque at the moment of engagement of the gear are controlled.

Finally, the electric machine and the combustion engine are controlled to apply the torque requested for continued driving of the vehicle after the gearchanging method, which has been terminated when this has been obtained.

Computer program code for implementing a method according to the invention is suitably included in a computer program which is readable into a non-volatile internal memory of a computer, such as the internal memory of an electronic control unit of a motor vehicle. Such a computer program is suitably provided through a computer program product comprising a data storing medium readable by an electronic control unit, which data storing medium has the computer program stored thereon. Said data storing medium is for example an optical data storing medium in the form of a CD-ROM-disc, a DVD-disc, etc., a magnetic data storing medium in the form of a hard disc, a diskette, a tape etc., or a Flash memory or a memory of the type ROM, PROM, EPROM or EEPROM.

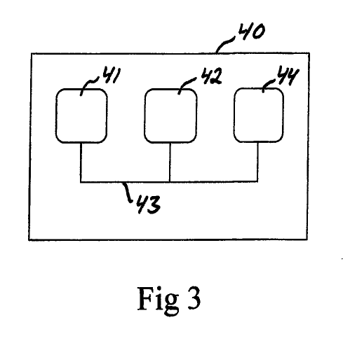

FIG. 3 illustrates very schematically an electronic control unit 40 comprising an execution means 41, such as a central processor unit (CPU), for executing a computer program. The execution means 41 communicates with a memory 42, for example of the type RAM, through a data bus 43. The control unit 40 comprises also a data storing medium 44, for example in the form of a Flash memory or a memory of the type ROM, PROM, EPROM or EEPROM. The execution means 41 communicates with the data storing medium 44 through a data bus 43. A computer program comprising computer program code for implementing a method according to the invention, for example in accordance with the embodiment illustrated in FIG. 4, is stored on the data storing medium 44.

The invention is of course not in any way restricted to the embodiments described above, but many possibilities to modifications thereof would be apparent to a person with skill in the art without departing from the scope of the invention as defined in the appended claims.

The locking means may be designed to interlock any two of said three components.

A transmission could be arranged between the rotor and the ring gear and also between the output shaft of the combustion engine and the sun gear, such as upstream of the shaft shown in the figures to be connected to the sun gear. The transmission last mentioned could also be formed by a variable gear.

It is also conceivable that the method is carried out for a vehicle having the ring gear as the first component and the sun gear as the third component, although the opposite would probably often be preferred through the advantages thereof mentioned above.

1. A method for gearchange in a vehicle gearbox during driving of the vehicle wherein the vehicle has a propulsion system comprising:
a combustion engine with and output shaft, a gearbox with an input shaft, an electric machine comprising a stator and a rotor, and a planetary gear comprising three components in the form of a sun gear, a ring gear and a planet wheel carrier;
the output shaft of the combustion engine being connected to a first of the components of the planetary gear so that rotation of the output shaft causes rotation of the first component, the input shaft of the gearbox being connected to a second of the components of the planetary gear so that rotation of the input shaft causes rotation of the second component, and the rotor of the electric machine being connected to a third of the components of the planetary gear so that rotation of the rotor causes rotation of the third component;
the propulsion system further comprising locking means transferable between a locking position in which two of the components are interlocked, so that the three components rotate with the same rotational speed, and a releasing position in which the components are allowed to rotate with different rotational speeds;
the method comprising:
starting the method when the vehicle is driven with the locking means in the locking position,
controlling the electric machine and the combustion engine towards a state of together applying a zero torque to the input shaft of the gearbox,
a) disengaging the gear then engaged in the gearbox when the zero torque has been obtained by both the electric machine and the combustion engine,
b) controlling the electric machine and the combustion engine to each apply a torque to the input shaft of the gearbox for bringing the input shaft to a rotational speed which for the existing speed of the vehicle is synchronized with the shaft rotational speed for a gear to be engaged in the gearbox,
c) when the synchronized rotational speed is on the way to being obtained, starting a gearengaging procedure while simultaneously controlling the electric machine and the combustion engine towards a state of together obtaining a zero torque applied by them to the input shaft of the gearbox at the time for a completion of the gearengaging procedure, and then
d) controlling the electric machine and the combustion engine to apply a torque requested by each of them to the input shaft of the gearbox.

2. A method according to claim 1, further comprising during step c), calculating the time remaining until the synchronized rotational speed of the input shaft of the gearbox is obtained and comparing the calculated time with an expected time consumption for the gearengaging procedure, and starting the gearengaging procedure when the expected time consumption is equal to or has become shorter than the time consumption.

3. A method according to claim 1, further comprising performing the method in the propulsion system wherein the sun gear is the first component and the ring gear is the third component.

4. A method according to claim 1, further comprising in step c) applying a constant torque through the electric machine, and/or applying a constant torque through the combustion engine to the input shaft of the gearbox.

5. A method according to claim 1, further comprising when engaging a higher gear in the gearbox in step d) than the gear engaged when performance of the method was started, controlling the combustion engine in step c) to apply a negative braking torque, to the input shaft of the gearbox by activating an exhaust gas brake of the vehicle and/or by activating a variable geometry turbo for applying a negative torque to the input shaft of the gearbox.

6. A method according to claim 1 performed for a vehicle having the sun gear and the planet wheel carrier interlocked through the locking means.

7. A method according to claim 1, further comprising:
for the existing speed of the vehicle, step c) comprises calculating the rotational speed which the input shaft of the gearbox would have if the gear of the gearbox which is to be engaged, would be engaged and calculating the rotational speed of the third component and the rotational speed of the output shaft of the combustion engine which together would give the input shaft of the gearbox the calculated rotational speed for the gear to be engaged.

8. (canceled)

9. A computer program product comprising a non-volatile data storing medium readable by a computer, and on which a computer program code of a computer program is stored, wherein the computer program code is for causing a computer to implement a method according to claim 1 when the computer program code is executed in the computer.

10. An electronic control unit of a motor vehicle comprising an execution means, a memory connected to the execution means and a non-volatile data storing medium connected to the execution means, and in which the computer program code of a computer program product according to claim 9 is stored on the data storing medium.

11. A vehicle comprising an electronic control unit according to claim 10.
